(19) United States
(12) Patent Application Publication
(10) Pub. No.: US 2006/0077271 A1
(43) Pub. Date: Apr. 13, 2006

(54) Amplification type solid-state image pickup device

(75) Inventor: Takashi Watanabe, Soraku-gun (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/215,558

(22) Filed: Aug. 29, 2005

(30) Foreign Application Priority Data
Aug. 30, 2004 (JP) 2004-249942

(51) Int. Cl. H04N 5/335

(52) U.S. Cl. 348/301; 348/300

(57) ABSTRACT

The amplifying solid-state image pickup device comprises a pixel section 10 and a control section 20. The control section 20 stores signal charges into the photodiode 1, and then writes the reset signal, by which the input of the inverting amplifier has been reset, into the first capacitance element 7 and the second capacitance element 9. The control section 20 writes the signal stored in the photodiode 1 into only the first capacitance element 7, and then outputs the signal, which has been stored in the photodiode 1 and written in the first capacitance element 7, to the signal line 11, and outputs the reset signal, which has been written in the second capacitance element 9, to the signal line 11.

This nonprovisional application claims priority under 35 U.S.C. §119(a) on Patent Application No(s). 2004-249942 filed in Japan on Aug. 30, 2004, the entire contents of which are hereby incorporated by reference.

### BACKGROUND OF THE INVENTION

The present invention relates to an amplification type solid-state image pickup device having an amplifying circuit in its pixel section. In particular, the present invention relates to an amplifying solid-state image pickup device which is provided with a plurality of pixels each having a photoelectric conversion element and a transfer transistor for transferring the signal charges of the photoelectric conversion element, wherein signals from the pixels are amplified and read out to the signal line.

In general, an amplifying solid-state image pickup device has been widely used which has a pixel section having an amplifying function and a scanning circuit disposed around the pixel section, wherein pixel data is read out from the pixel section by the scanning circuit.

As an example of such an amplifying solid-state image pickup device, an active pixel sensor (APS) type image sensor composed of complementary metal oxide semiconductors (CMOSs) is known which is advantageous for integration of the pixel section with the peripheral drive circuit and signal processing circuit.

In the APS type image sensor, signals from the many pixels arranged in two dimensions are typically read out in sequence by row.

The APS type image sensor has a problem that an image distortion occurs for a moving subject, because exposure periods vary with respect to each row at a shutter operation providing a short exposure time. This will be explained with reference to FIG. 7.

FIG. 7 shows the operation of a amplifying solid-state image pickup device in background art.

In FIG. 7, when an input image (A) shaped like a straight line rotates in a counterclockwise direction, positions of the image at times t1, t2, t3, t4, and t5 are as shown with broken lines in the figure. On the other hand, positions in the vertical scanning direction of the image read by an APS type image sensor at times t1, t2, t3, t4 and t5 vary as shown in the figure. For this reason, an image to be read which is obtained by tracing the image positions at the each reading scanning times become the distorted image as shown with a solid line (B).

FIG. 8 shows a four-transistor type structure (see, e.g., Japanese unexamined patent publication No. 2002-320141) capable of avoiding this problem, and FIG. 9 shows an operation timing for various signals of the four-transistor type structure.

In FIG. 8, Cs is a capacitance, V_{R} is a reset drain power supply, and V_{D} is an output drain power supply. Furthermore, in FIG. 8, φ_{TX} is a drive pulse for the transfer section M1, φ_{RS} is a drive pulse for the reset section M2, and φ_{SL} is a drive pulse for the pixel selecting section M4. Furthermore, Vₒᵤₜ is an output signal outputted from the vertical signal line.

As shown in FIG. 8, the four-transistor type structure in background art has a photodiode PD which is a photoelectric conversion section. In the conventional four-transistor type structure, the transfer section M1 for transferring the signal charges stored in the photodiode PD, the amplifying section M3, the reset section M2, and the pixel selecting section M4 are composed of transistors.

In the four-transistor type structure in background art shown in FIG. 8, as shown in FIG. 9, at first, in the period T_{R}, By turning on the transfer section drive pulse φ_{TX}, that is to say, by becoming the transfer section drive pulse φ_{TX} to the high level, the reset section drive pulse φ_{RS} is turned on (is turned to the high level) while keeping the electric potential of the charge detecting section FD fixed to V_{R}, thereby discharging the signal charges from the photodiode PD to the charge detecting section FD and resetting the photodiode.

Next, exposure is performed in the period T_{INT}. That is, in the period T_{INT} between turning off the transfer section drive pulse φ_{TX} (to the low level) and turning on the pulse φ_{TX} again, signal charges generated by photoelectric conversion are stored in the photodiode PD. The period T_{INT} is an exposure period. At the end of the period T_{INT}, the electric potential of the charge detecting section FD is brought to a floating state by changing the pulse φ_{RS} from the ON state to the OFF state, thus resetting the FD section.

Next, in the period T_{W}, by turning on the transfer section drive pulse φ_{TX}, the signal charges stored in the photodiode in the exposure period T_{INT} are transferred to the FD section and are written in the FD section.

In the periods T_{R}, T_{INT} and T_{W}, all the pixels are operated with the same timing, and the exposure operations and storage operations for all the pixels are performed at the same time. In the way, even if shutter operation whose exposure period T_{INT} is short is performed, the simultaneity of the whole of the screen is gotten without problems and even a moving subject can be imaged without distortion.

Next, in the period T_{S}, the signal charges written in the FD sections are read out in sequence by row. In detail, at first, in the period T₁, the signal level written in the FD section is read out. Next, in the period T₂, the pulse φ_{RS} is turned on to reset the FD section. After that time, in the period T₃, the reset level of the FD section is read out. After that time, the subtraction between the signal level in the period T₁ and the reset level in the period T₃ is performed at a subsequent stage by a well known correlated double sampling (CDS) operation, and thereby eliminating predetermined pattern noises caused by variations in the threshold voltages of the amplifying transistors M3 for each pixels, etc.

However, the four-transistor type structure described above has the following problems.

That is, on the signal level in the period T₁, the reset noise Vₙ₁ caused by the reset in the previous period T_{W} is superimposed, while on the reset level in the period T₃, the reset noise Vₙ₂ caused by the reset in the previous period T₂ is superimposed. The reset noises vary in a random fashion every reset, and thus there is no correlation between Vₙ₁ and Vₙ₂. For this reason, even if the subtraction between the reset noises Vₙ₁ and Vₙ₂ is performed, the noise of (Vₙ₁²+Vₙ₂²)^{1/2} is remained which is larger than the reset noises and there is a problem that to vanish the reset noises is impossible. This noise becomes a noise varying in a random fashion in the image, thereby significantly reducing the S/N ratio of the image.

The four-transistor type structure also has the following problem.

In FIG. 9, the signal charge written into the FD section in the period T_{W} should not change during the period T_{S} the signal charge is held in the FD section. However, in the four-transistor type structure described above, as shown in FIG. 8, the FD section is adjacent to the photodiode PD via the transfer gate M1, so that the signal deteriorates (changes) in the period T_{S} during which it is held in the FD section.

FIG. 10 is the figure drawn for explaining this problem.

As shown in FIG. 10, on the p-type substrate 101, an n-type photoelectric conversion storage section 102 and a pinning layer 103 for fixing the surface electric potential are formed as a photodiode. Furthermore, a transfer gate 106 and a charge detecting section 104 are formed adjacent to the photodiode. On the charge detecting section 104, a light blocking layer 107 is formed.

Because of this configuration, when there is oblique incident light in the period T_{S} during which the signal is held in the FD section, part of the incident light reaches the charge detecting section 104, and charges generated by photoelectric conversion deteriorate (change) the signal held in the charge detecting section 104. Furthermore, the incident light which has reached the underside of the photoelectric conversion storage section 102 generates charges by photoelectric conversion, and the generated charges reach the charge detecting section 104 by diffusion and deteriorate the signal in the period T_{S} during which it is held in the charge detecting section 104.

### SUMMARY OF THE INVENTION

It is therefore an object of the present invention to provide an amplifying solid-state image pickup device capable of imaging a moving subject without distortion, capable of suppressing the reset noise and thus obtaining an image of a high S/N ratio, and capable of preventing the signal from deteriorating in the period during which it is held.

In order to accomplish the above object, there is provided, according to the present invention, an amplifying solid-state image pickup device comprising:

at least one pixel having a photoelectric conversion element and a transfer transistor for transferring signal charges from the photoelectric conversion element;

a switched capacitor-amplifier section in which a first path having a first switching element and a first capacitance element connected in series with each other, an inverting amplifier, and a reset use switching element are connected in parallel; and

a control section which turns off the transfer transistor to store signal charges into the photoelectric conversion element, and then performs a first reset operation of resetting an input of the inverting amplifier by the reset-use switching element, and then turns on the transfer transistor in a predetermined period of time with the first switching element turned on and the reset use switching element turned off to write signal charges stored in the photoelectric conversion element into the first capacitance element, and then turns on the first switching element to output the signal charges which have been written in the first capacitance element from the switched capacitor-amplifier section.

According to the present invention, the signal of the photoelectric conversion element is written into the first capacitance element, and is then read out from the first capacitance element, so that the signal can be read out with a required timing and can be prevented from deteriorating in the period during which the signal is held. In the present invention, two kinds of reset operations are performed. The first reset operation is an operation of resetting the input of the inverting amplifier. Just after the reset, the signal charges from the photoelectric conversion element are transferred to the input of the inverting amplifier. A signal obtained after the reset and a signal obtained after the signal charge transfer are read out separately, and then the subtraction between the signals is performed at a subsequent stage, so that the net signal is detected. On the other hand, an operation of resetting the photoelectric conversion element to the initial state is the second reset operation, which differs from the first reset operation.

In one embodiment, the switched capacitor-amplifier section has a second path which is connected with the first path in parallel and has a second switching element and a second capacitance element connected in series with each other; and

the control section writes the reset signal used when the first reset operation is performed into the first capacitance element and the second capacitance element by turning on the first switching element and the second switching element, and then writes signal charges stored in the photoelectric conversion element into only the first capacitance element by turning on the first switching element and turning off the second switching element, and then outputs the signal charges, which have been written in the first capacitance element by turning on the first switching element, from the switched capacitor-amplifier section, and outputs the reset signal, which has been written in the second capacitance element by turning on the second switching element, from the switched capacitor-amplifier section.

According to the embodiment, after the reset signal of the photoelectric conversion element is written into the first capacitance element and the second capacitance element, signal charges stored in the photoelectric conversion element are written into only the first capacitance element, and then signal charges written in the first capacitance element are output from the switched capacitor-amplifier section, and the reset signal written in the second capacitance element is output from the switched capacitor-amplifier section. Thus, in an amplifying solid-state image pickup device according to this embodiment, the reset noise can be eliminated by, for example, performing the subtraction between the reset signal and the signal of the photoelectric conversion element by a CDS operation at a subsequent stage. Consequently, a moving subject can also be imaged without distortion and the noise can be significantly reduced, so that a good image without noise can be obtained.

In one embodiment, there are two or more pixels which are identical to the pixel, and

the control section writes signals of all the photoelectric conversion elements of a plurality of the pixels into the first capacitance element at the same time.

According to the embodiment, the control section writes the signals of all the photoelectric conversion elements into the first capacitance element at the same time, so that the time to write the signals can be made shorter.

In one embodiment, the control section writes the signals of all the photoelectric conversion elements into the first capacitance element at the same time after performing a second reset operation of resetting a signal of the photoelectric conversion element for all the photoelectric conversion elements at the same time.

According to the embodiment, the second reset operations for all the photoelectric conversion elements are performed at the same time, so that the signals of all the photoelectric conversion elements can be then written into the first capacitance element. Furthermore, the image information of all the photoelectric conversion elements is captured with the same timing, so that a moving subject can also be imaged without distortion at all.

In one embodiment, there are two or more pixels which are identical to the pixel, and

the control section writes signals of all the photoelectric conversion elements of a plurality of the pixels into the first capacitance element in sequence.

According to the embodiment, the control section writes the signals of all the photoelectric conversion elements into the first capacitance element in sequence, so that the concentration of the drive currents can be prevented, and therefore the destruction of the components can be prevented.

In one embodiment, the control section writes signals of all the photoelectric conversion elements into the first capacitance element in sequence after performing a second reset operation of resetting a signal of the photoelectric conversion element for all the photoelectric conversion elements in sequence.

According to the embodiment, the second reset operations for all the photoelectric conversion elements are performed in sequence, and then the signals of all the photoelectric conversion elements are written into the first capacitance element in sequence, so that the image information of all the photoelectric conversion elements can be captured in a short time while preventing the concentration of the readout currents by performing the second operations and writing operations at high speed.

In one embodiment, the photoelectric conversion element is a pinned photodiode.

According to the embodiment, the photoelectric conversion element is a pinned photodiode, so that the noise by a dark current generated in the photoelectric conversion element can be significantly reduced. Thus, the noise of the whole of the pixel section can be significantly reduced by the synergistic effect with the reduction of reset noise by the CDS operation at a subsequent stage.

According to the present invention, the signal of the photoelectric conversion element is written into the first capacitance element, and is then read out from the first capacitance element, so that the signal can be read out with a required timing and can be prevented from deteriorating in the period during which the signal is held.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a circuit diagram showing part of an amplifying solid-state image pickup device according to one embodiment of the present invention.

FIG. 2 is a timing chart of one embodiment of the amplifying solid-state image pickup device the configuration of which is shown in FIG. 1.

FIG. 3 is a timing chart of another embodiment of the amplifying solid-state image pickup device the configuration of which is shown in FIG. 1.

FIG. 4 shows an amplifying solid-state image pickup device according to the present invention having a configuration different with that in FIG. 1.

FIG. 5A is a partial circuit diagram of an amplifying solid-state image pickup device having one capacitor per pixel.

FIG. 5B is a partial circuit diagram of an amplifying solid-state image pickup device having one capacitor per pixel.

FIG. 6 is a cross-sectional view of part of an amplifying solid-state image pickup device according to one embodiment of the present invention.

FIG. 7 shows the operation of a conventional amplifying solid-state image pickup device.

FIG. 8 shows a conventional four-transistor type structure.

FIG. 9 shows an operation timing of the four-transistor type structure.

FIG. 10 is a cross-sectional view showing the layer structure of a conventional amplifying solid-state image pickup device.

### DETAILED DESCRIPTION OF THE INVENTION

Amplifying solid-state image pickup devices according to the present invention are described in detail below with reference to the embodiments shown in the figures.

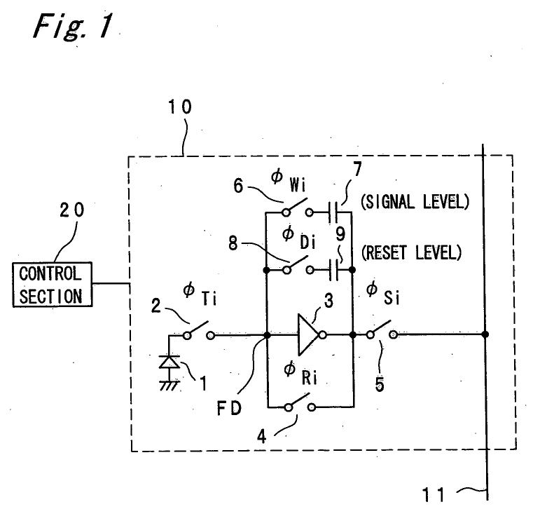

FIG. 1 is a circuit diagram showing part of an amplifying solid-state image pickup device according to one embodiment of the present invention.

This amplifying solid-state image pickup device comprises a pixel section 10 and a control section 20.

The pixel section 10 comprises a pixel, a switched capacitor-amplifier section, and a selecting section 5.

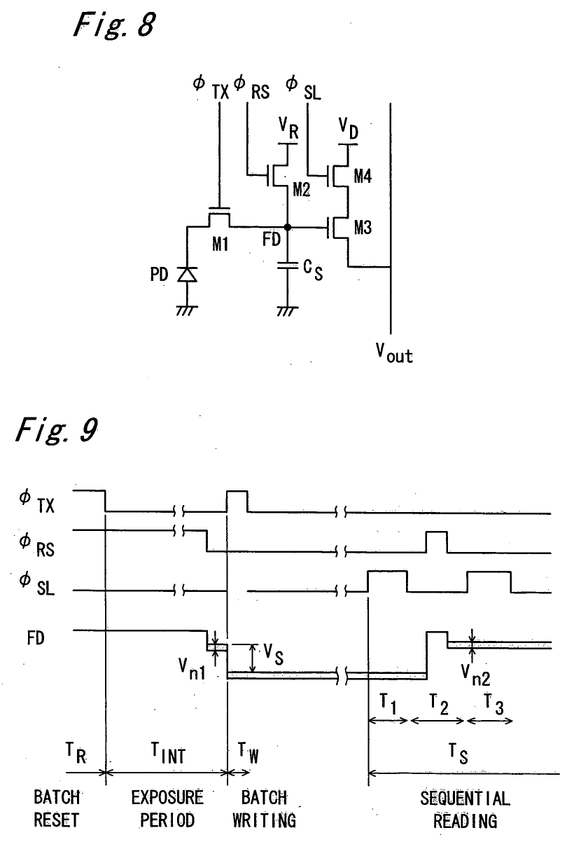

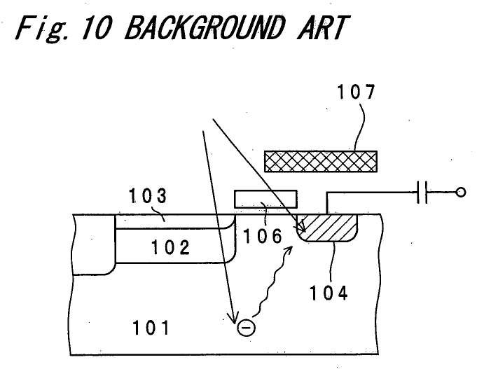

The pixel consists of a pinned photodiode (a buried photodiode) 1 which is an example of a photoelectric conversion element, and a transfer section 2 which plays a role of transferring the signal charges of the photodiode 1 to the detecting section FD and consists of a transfer transistor having a structure such as M1 in FIG. 8.

The switched capacitor-amplifier section consists of an inverting amplifier 3 for transferring a signal from the transfer section 2 to the capacitance element, a reset section 4 consisting of a reset-use switching element for resetting the detecting section FD to an electric potential generated when the input and output of the inverting amplifier 3 are shorted to each other, and the capacitance element for storing signal charges. The capacitance element consists of a first capacitance element 7 for holding a signal from the photodiode 1 and a second capacitance element 9 for holding a reset level. The first capacitance element 7 is connected in series with a first switching element 6 for controlling it, and the second capacitance element 9 is connected in series with a second switching element 8 for controlling it.

The reset section 4 consisting of a reset transistor acts as a switching element. The first capacitance element 7 and the first switching element 6 constitute a first path, and the second capacitance element 9 and the second switching element 8 constitute a second path. The first switching element 6 and the second switching element 8 are composed of transistors.

The selecting section 5 is a switching element composed of one or more transistors. The selecting section 5 plays a role of outputting signals from the first capacitance element 7 and the second capacitance element 9 to the signal line 11.

The control section 20 controls the driving of the transfer section 2, reset section 4, selecting section 5, first switching element 6, and second switching element 8 by applying signals φ_{Ti}, φ_{Ri}, φ_{Si}, φ_{Wi}, and φ_{Di} to the transfer section 2, reset section 4, selecting section 5, first switching element 6, and second switching element 8, respectively (suffix i means the ith row pixel section).

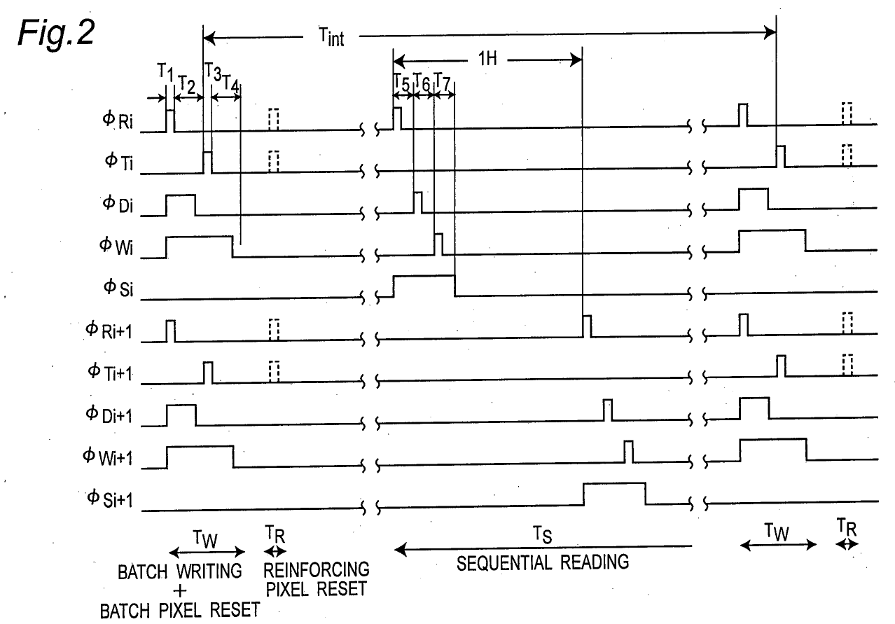

FIG. 2 is a timing chart of one embodiment of the amplifying solid-state image pickup device the configuration of a pixel section of which is shown in FIG. 1.

The operation of the amplifying solid-state image pickup device is described below with reference to FIG. 2.

At first, in the period T_{W}, writing operations and pixel reset (second reset) operations for all the pixels are simultaneously performed en bloc. Since the same operations are also performed in a period T_{W} of one frame (Tᵢₙₜ) ago, signal charges generated in the photodiode in the period Tᵢₙₜ have been stored in the photoelectric conversion element at the beginning of the period T_{W}.

In detail, in the first period T₁ of T_{W}, the electric potential of the detecting section FD is reset (first reset) by turning on the reset pulse φ_{R1}, and the reset level of FD is held in the first capacitance element 7 and the second capacitance element 9 by turning on the switches φ_{Wi} and φ_{Di}.

Next, in the period T₂ subsequent to the period T₁, the pulse φ_{Di} is turned off (to the low level) to write the reset level of FD into the second capacitance element 9, and then in the period T₃, the transfer pulse φ_{Ti} is turned on to transfer the signal charges stored in the photodiode in the period Tᵢₙₜ of one frame ago to the FD section. At that time, the signal level of FD is held in the first capacitance element 7 by turning on the pulse φ_{Wi}.

Finally, in the period T4 subsequent to the period T3, the pulse φ_{Wi} is turned off to write the signal level of FD into the first capacitance element 7. The above operations are performed for all the pixels at the same time.

In the above write operation, the reset of the FD section is performed one time only in the period T₁, at this time a write-time reset noise V_{nw} is generated. The reset level held in the second capacitance element 9 and the signal level held in the first capacitance element 7 have the same reset noise V_{nw}. Furthermore, in the period T1, when the first capacitance element 7 and the second capacitance element 9 are reset, the first switching element 6 and the second switching element 8 are both turned on, so that a common kTC noise Vktc is written into the first capacitance element 7 and the second capacitance element 9.

In this amplifying solid-state image pickup device, in each of the pixels, writing of the rest level and writing of the signal level are simultaneously performed, and then in the period Ts, operations of reading out levels from the pixels are performed in sequence on every other row. In detail, at first, in the (i)th row pixel, in the period T₅, the reset pulse φ_{Ri} is turned on to reset the electric potential of the detecting section FD.

After that, in the period T₆, the pulse φ_{Di} etc. are turned on to read out the reset level held in the second capacitance element 9, and then in the period T₇, the pulse φ_{Wi} is turned on to read out the signal level held in the first capacitance element 7. After one horizontal scanning period shown with 1 H in FIG. 2 has finished, operations similar to ones described above are performed in the (i+1)th row pixel.

In the amplifying solid-state image pickup device of this embodiment, the read operations are performed in sequence every other row, while the images have been captured at the same time, and therefore even a moving subject can be taken an image without distortion. In the above read operations, the FD section is reset one time only in the period T₅, at this time a read-time reset noise Vₙᵣ is generated. On the reset level read out from the second capacitance element 9 and on the signal level read out from the first capacitance element 7, the same reset noise Vₙᵣ is superimposed.

As described above, in this amplifying solid-state image pickup device, common write-time reset noise V_{nw}, kTC noise V_{ktc}, and read-time reset noise Vₙᵣ are superimposed on the two signals, that is, the reset level held in the second capacitance element 9 and the signal level held in the first capacitance element 7. For this reason, by performing the subtraction between the two signals by a CDS operation at a subsequent stage, which is not shown in the figures, both of the reset noises and the kTC noise can be eliminated, so that only the signal components can be extracted. Consequently, we can obtain an image which has a significantly less noise and is clearer than that of a conventional one.

The pixel reset (second reset) operation in the period T_{W} is an operation of turning on the transfer pulse φ_{T} to transfer the signal charges stored in the photodiode to the FD section in the period T₃. However, if great many signal charges have been stored in the photodiode, this operation may not be sufficient to reset the pixel. In this case, as shown with the broken line in FIG. 2, a reinforcing pixel reset operation of turning on the reset pulse φ_{R} and the transfer pulse φ_{T} again in the period T_{R} may be performed.

When the timing shown in FIG. 2 is adopted, an operation and effect such as being able to eliminate both of the reset noises and the kTC noise can be obtained, while there is a problem that the inverting amplifiers in all the pixel sections are required to be simultaneously driven at the pixel reset operation and the write operation in the period TW (and the period TR), so that instantaneously large current flows because of the concentration of the drive currents.

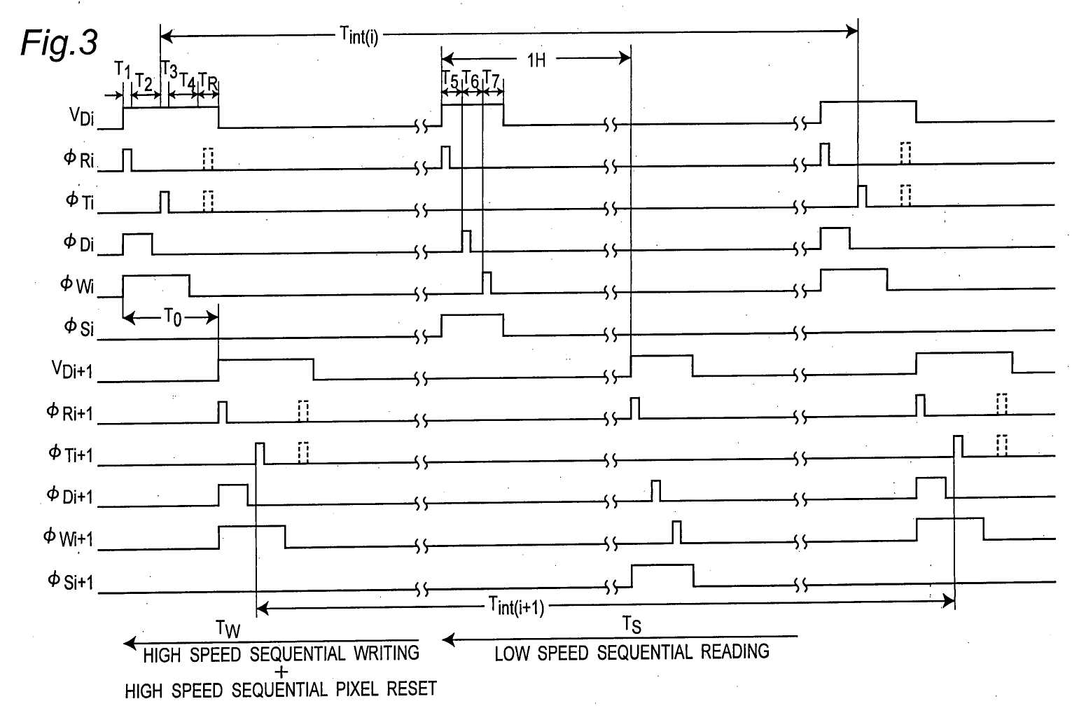

FIG. 3 is a timing chart of another embodiment of the amplifying solid-state image pickup device the configuration of which is shown in FIG. 1. This timing chart shows timing capable of avoiding the instantaneously large current described above.

At first, in the period T_{W}, write operations and pixel reset (second reset) operations for all the pixels are performed in sequence at high speed in a period T₀ per row. Since the same operations are also performed in the period T_{W} of one frame (Tᵢₙₜ) ago, for each row the signal charges generated in the photodiode in the period Tᵢₙₜ are stored in the photoelectric conversion element at the beginning of the period T₀.

In the period T_{W}, the inverting amplifier of the (i)th row's pixel is driven only in the period during which the pulse V_{Di} is at the high level. Operations in the periods T1, T2, T3, and T4 in this period are similar to those in FIG. 2. That is, writing of signal charges generated and stored in the photodiode in the period Tᵢₙₜ and a pixel reset (second reset) are performed every row. These operations are performed in sequence at high speed in a period To per row, and writing operations for all the pixels of n rows are completed in the period of nT₀. In this operation timing chart, the inverting amplifies are driven every row even at pixel reset operations as well as at writing operations, so that the concentration of the drive currents can be surely prevented.

Next, in the period Ts, the read operations for the pixels are performed in sequence every other row just as in the case of FIG. 2.

For the timing chart shown in FIG. 3, the period of nT₀ is required to perform the second reset operations and writing operations. More specifically, since T₀ is usually the order of 1 μs, if the number of pixels of the screen is the order of 640×480 (VGA), the second reset operations and writing operations for the whole of the screen can be completed in the order of 0.5 ms. This period of time corresponds to the shutter time of 1/2000 seconds, so that even a moving subject can also be imaged with a very little distortion.

As in the case of FIG. 2, the pixel reset (second reset) operation in the period T_{W} is an operation of turning on the transfer pulse φ_{T} to transfer the signal charges stored in the photodiode to the FD section in the period T₃. However, if great many signal charges have been stored in the photodiode, this operation may not be sufficient to reset the pixel. In this case, as shown with the broken line in FIG. 3, a reinforcing pixel reset operation of turning on the reset pulse φ_{R} and the transfer pulse φ_{T} again in the period T_{R} during which the pulse V_{D} is at the high level may be performed.

Although the amplifying solid-state image pickup device shown in FIG. 1 is configured that the pixel section 10 comprises one pixel and one switched capacitor-amplifier section, an amplifying solid-state image pickup device according to the present invention is, of course, not limited to this configuration.

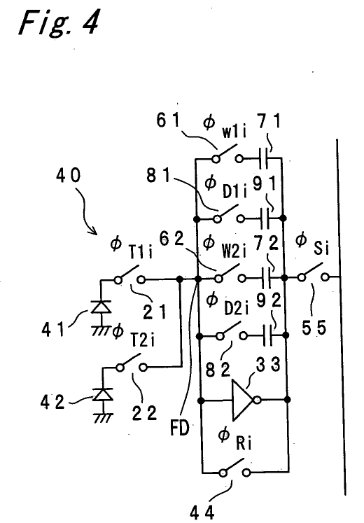

FIG. 4 shows an amplifying solid-state image pickup device according to the invention having a configuration different with one shown in FIG. 1.

The pixel section 40 of this amplifying solid-state image pickup device comprises two pixels and one switched capacitor-amplifier section.

The two pixels are connected in parallel. One of the two pixels has a pinned photodiode (a buried photodiode) 41 which is an example of a photoelectric conversion element, and a transfer section 21 which plays a role of transferring the signal charges of the photodiode 41 to the detecting section FD and consists of a transfer transistor. The other one of the two pixels has a pinned photodiode (a buried photodiode) 42 which is an example of a photoelectric conversion element, and a transfer section 22 which plays a role of transferring the signal charges of the photodiode 42 to the detecting section FD and consists of a transfer transistor.

The switched capacitor-amplifier section consists of an inverting amplifier 33 for transferring a signal from the transfer section 21, 22 to the capacitance element, a reset section 44 consisting of a reset-use switching element for resetting the detecting section FD to an electric potential generated when the input and output of the inverting amplifier 33 are shorted to each other, and the capacitance element for storing signal charges.

The capacitance element consists of first capacitance elements 71 and 72 for holding signals from the photodiodes, and second capacitance elements 91 and 92 for holding reset levels. The first capacitance element 71 is connected in series with a first switching element 61 for controlling it, and the first capacitance element 72 is connected in series with a first switching element 62 for controlling it. The second capacitance element 91 is connected in series with a second switching element 81 for controlling it, and the second capacitance element 92 is connected in series with a second switching element 82 for controlling it. The first switching element 61, first switching element 62, second switching element 81, and second switching element 82 are composed of transistors. The first capacitance element 71 and the first switching element 61 constitute a first path, and the first capacitance element 72 and the first switching element 62 constitute a first path. The second capacitance element 91 and the second switching element 81 constitute a second path, and the second capacitance element 92 and the second switching element 82 constitute a second path.

The pixel section 40 has a selecting section 55 which is a switching element composed of transistors. The selecting section 55 plays a role of outputting signals from the first capacitance element 71, first capacitance element 72, second capacitance element 91 and second capacitance element 92 to the signal line.

In FIG. 4, φ_{T1i}, φ_{T2i}, φ_{Ri}, φ_{Si}, φ_{W1i}, φ_{W2i}, φ_{D1i}, and φ_{D2i} are pulse signals applied from the drive section not shown in the figure to the transfer section 21, transfer section 22, reset section 44, selecting section 55, switching element 61, switching element 62, switching element 81, and switching element 82, respectively. The suffix i means the (i)th row's pixel section.

The amplifying solid-state image pickup device shown in FIG. 4 differs from the amplifying solid-state image pickup device shown in FIG. 1 only in that one switched capacitor-amplifier section is used for two rows.

In the amplifying solid-state image pickup device shown in FIG. 4, at first, a writing operation similar to that of the device shown in FIG. 1 is performed for the capacitance elements 71 and 91 with respect to an odd-numbered row, and then a writing operation similar to that of the device shown in FIG. 1 is performed for the capacitance elements 72 and 92 with respect to an even-numbered row. And these series of operations are repeated in sequence every two rows. Furthermore, a reading operation similar to that of the device shown in FIG. 1 is performed for the capacitance elements 71 and 91 with respect to an odd-numbered row, and then a reading operation similar to that of the device shown in FIG. 1 is performed for the capacitance elements 72 and 92 with respect to an even-numbered row. And these series of operations are repeated in sequence every two rows.

In the amplifying solid-state image pickup device shown in FIG. 4, since signal processing for two pixels is performed with one switched capacitor-amplifier section, so that the number of transistors per pixel can be reduced.

The amplifying solid-state image pickup device shown in FIG. 4 has one switched capacitor-amplifier section commonly used for two pixels, so that the input capacitance of the switched capacitor-amplifier section increases However, the influence of input capacitance can be suppressed by using an inverting amplifier having a sufficiently high gain.

In the amplifying solid-state image pickup devices shown in FIGS. 1 and 4, there are two capacitance elements per pixel. However there may be one capacitance element per pixel, in this case, for whole of the light receiving area writing operations can be performed at a time, and reading operations can be performed in sequence.

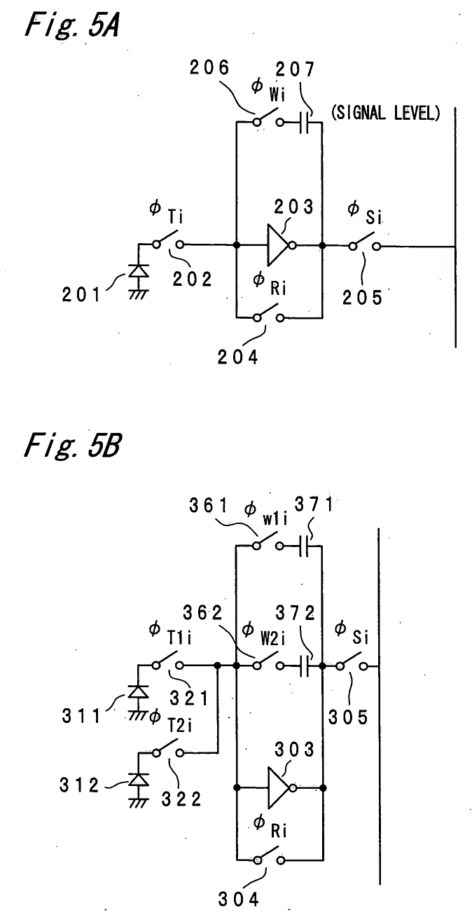

Each of FIGS. 5A and 5B is a partial circuit diagram of an amplifying solid-state image pickup device having one capacitor per pixel.

In FIGS. 5A and 5B, reference numerals 201, 311, and 312 each denote a pinned photodiode (a buried photodiode), and reference numerals 202, 321, and 322 each denote a transfer section consisting of a switching element. Reference numerals 203 and 303 each denote an inverting amplifier, and reference numerals 204 and 304 each denote a reset section consisting of a reset-use switching element. Further, reference numerals 205 and 305 each denote a selecting section consisting of a switching element, reference numerals 206, 361, and 362 each denote a first switching element, and reference numerals 207, 371 and 372 each denote a first capacitance element. The various switching elements described above are composed of transistors.

The first switching element 206 and first capacitance element 207, the first switching element 361 and first capacitance element 371, and the first switching element 362 and first capacitance element 372 each constitute a first path.

The signals φ_{Ti}, φ_{Ri}, φ_{Si}, φ_{Wi}, φ_{T1i}, φ_{T2i}, φ_{Ri}, φ_{Si}, φ_{W1i}, and φ_{W2i} are pulse signals outputted from the drive section not shown in the figures to the various switching elements described above.

The amplifying solid-state image pickup devices shown in FIGS. 5A and 5B are not able to reduce the reset noise, whereas its devices are able to image a moving subject without distortion. And its devices are able to reduce the number of capacitors per pixel and are able to be downsized as compared with the devices shown in FIGS. 1 and 4.

In the amplifying solid-state image pickup device shown in FIG. 4, signal processing for two pixels is performed with one switched capacitor-amplifier section. However, in the present invention, signal processing for more pixels such as 4 to 8 pixels may be performed with one switched capacitor-amplifier section. In this case, the number of transistors per pixel can be more reduced, and thereby the manufacturing cost can be more reduced.

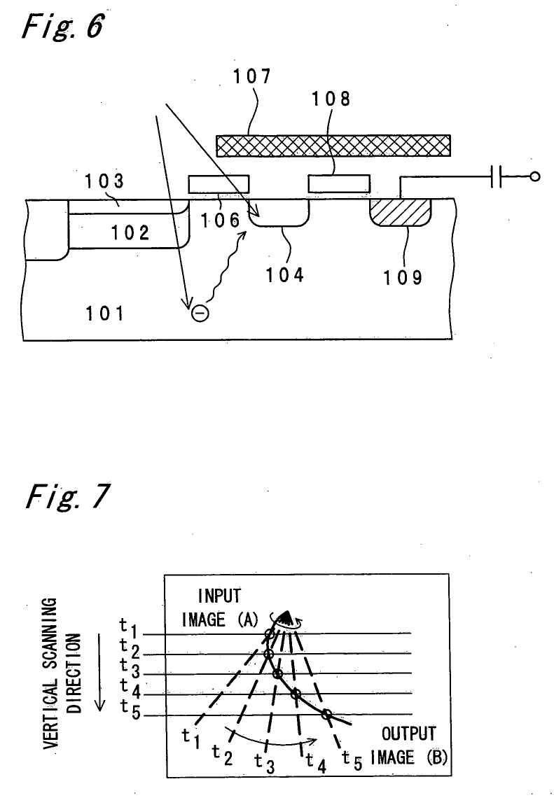

FIG. 6 is a cross-sectional view of part of an amplifying solid-state image pickup device according to one embodiment of the present invention.

Another advantage of the present invention is described below with reference to FIG. 6.

This amplifying solid-state image pickup device comprises a p-type substrate 101, an n-type photoelectric conversion storage section 102 which is a photodiode formed on the p-type substrate 101, and a pinning layer 103, for fixing a surface electric potential, formed on the photoelectric conversion storage section 102.

Furthermore, a transfer gate 106 is formed on a portion adjacent to the photodiode on the p-type substrate 101, and a charge detecting section 104 is formed in a portion adjacent to the transfer gate 106 on the p-type substrate 101.

Furthermore, a light blocking layer 107 is formed on the charge detecting section 104. In the amplifying solid-state image pickup device shown in FIG. 6, there is a switching gate 108 next to the charge detecting section 104. The charge detecting section 104 is connected to the terminal 109 of the capacitor via the switching gate 108.

In this configuration, oblique incident light can be prevented almost completely from reaching the terminal 109 of the capacitor, and the charges generated by photoelectric conversion by the incident light which has reached the underside of the photoelectric conversion storage section 102 can also be prevented almost completely from reaching the terminal 109 of the capacitor. Consequently, we can significantly reduce the extent to which a signal is deteriorated by incident light in the period T_{S} during which the signal is held in the charge detecting section 104.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An amplifying solid-state image pickup device comprising:
at least one pixel having a photoelectric conversion element and a transfer transistor for transferring signal charges from the photoelectric conversion element;
a switched capacitor-amplifier section in which a first path having a first switching element and a first capacitance element connected in series with each other, an inverting amplifier, and a reset use switching element are connected in parallel; and
a control section which turns off the transfer transistor to store signal charges into the photoelectric conversion element, and then performs a first reset operation of resetting an input of the inverting amplifier by the reset-use switching element, and then turns on the transfer transistor in a predetermined period of time with the first switching element turned on and the reset use switching element turned off to write signal charges stored in the photoelectric conversion element into the first capacitance element, and then turns on the first switching element to output the signal charges which have been written in the first capacitance element from the switched capacitor-amplifier section.

2. The amplifying solid-state image pickup device according to claim 1, wherein:
the switched capacitor-amplifier section has a second path which is connected with the first path in parallel and has a second switching element and a second capacitance element connected in series with each other; and
the control section writes the reset signal used when the first reset operation is performed into the first capacitance element and the second capacitance element by turning on the first switching element and the second switching element, and then writes signal charges stored in the photoelectric conversion element into only the first capacitance element by turning on the first switching element and turning off the second switching element, and then outputs the signal charges, which have been written in the first capacitance element by turning on the first switching element, from the switched capacitor-amplifier section, and outputs the reset signal, which has been written in the second capacitance element by turning on the second switching element, from the switched capacitor-amplifier section.

3. The amplifying solid-state image pickup device according to claim 1, wherein
there are two or more pixels which are identical to the pixel, and
the control section writes signals of all the photoelectric conversion elements of a plurality of the pixels into the first capacitance element at the same time.

4. The amplifying solid-state image pickup device according to claim 3, wherein
the control section writes the signals of all the photoelectric conversion elements into the first capacitance element at the same time after performing a second reset operation of resetting a signal of the photoelectric conversion element for all the photoelectric conversion elements at the same time.

5. The amplifying solid-state image pickup device according to claim 1, wherein
there are two or more pixels which are identical to the pixel, and
the control section writes signals of all the photoelectric conversion elements of a plurality of the pixels into the first capacitance element in sequence.

6. The amplifying solid-state image pickup device according to claim 5, wherein
the control section writes signals of all the photoelectric conversion elements into the first capacitance element in sequence after performing a second reset operation of resetting a signal of the photoelectric conversion element for all the photoelectric conversion elements in sequence.

7. The amplifying solid-state image pickup device according to claim 1, wherein
the photoelectric conversion element is a pinned photodiode.
